(19) United States
(12) Patent Application Publication
(10) Pub. No.: US 2026/0160105 A1
(43) Pub. Date: Jun. 11, 2026

(54) DOOR CHECK GENERATING HALF OPENING FORCE

(71) Applicant: Edscha Japan Co.,Ltd., Yokohama Kanagawa (JP)

(72) Inventors: Naoki KATO, Yokohama Kanagawa (JP); Akihiko HATTORI, Yokohama Kanagawa (JP)

(21) Appl. No.: 19/412,365

(22) Filed: Dec. 8, 2025

(30) Foreign Application Priority Data
Dec. 10, 2024 (JP) 2024-215889

(51) Int. Cl. E05F 5/06

(52) U.S. Cl. CPC E05F 5/06; E05Y 2900/531

(57) ABSTRACT

This disclosure provides a door check of a hinged door including a door side component and a body side component. A check link arm is included in one of the door side component and the body side component and penetrates a housing, where the housing is included in the other of the door side component and the body side component. A stress generating structure generates elastic stress in a door opening direction at a fully closed state of the door and applies the stress directly onto the check link arm. The stress generating structure is configured to partially open the door by the stress when a latch, which maintains the door in the closed state, is released.

### CROSS-REFERENCE TO RELATED APPLICATIONS

This application claims the priority to and the benefit of Japanese Patent Application No. 2024-215889 filed on Dec. 10, 2024, which is incorporated by reference herein in its entirety.

### FIELD

The present invention relates to a door check suitable for use for a vehicle door.

More specifically, the present invention relates to a door check with a function allowing to create a gap where a finger can be hooked to open the door when a door latch is released in vehicle door without door handle, which have increased in recent years.

### BACKGROUND

In recent years, vehicle designs without door handles have emerged, aiming for elegant and less air resistant door design. In such designs, something to put fingers and to serve as a handle for moving the door is required to operate the door for opening. Hence, solutions such as recess on the body side for putting finger, or embedded door handle which appears only during operation and remain embedded in the door structure otherwise, were developed. However, these designs had numerous defects such as complicated structure, higher air resistance, and disadvantages in design.

Therefore, a structure was developed that did not use the recess or the embedded handle, and allowed open and close operation of the door without any problems in the simplest possible way, which is, when the door is completely closed and latched, then the latch is released to open the door, the door may be opened to a position where a gap being large enough to put finger(s) therein is provided, so to speak, a half-opened door, and from there finger can be inserted into the gap to apply force in the direction of opening the door.

In JP A 2015-086529, a pop-up mechanism for a vehicle door is disclosed, which improves door operability by doing door opening operation even when a user is in a situation where it is difficult to open the door.

However, this mechanism works as follows: “in a case where the user's both hands are full with luggage, for example, it is difficult for the user to operate the door” (see e.g., ¶ 0003), “comprising a first member configured to be supported at a vehicle body and to transmit a force to a door for a vehicle, a second member configured to store an external force applied to the second member and to transmit the force that is stored to the first member, and a trigger member releasing the force stored by the second member, the first member opening the door for the vehicle based on the force stored by the second member in a case where the trigger member releases the force stored by the second member” (see e.g., ¶ 0006), and “the second lever 4 moves with the operation of the check link 11, which rotates the second gear 41. When the second gear 41 rotates by the movement of the second lever 4, the first gear 31 which is meshed with the second gear 41 rotates so that the first lever 3 moves, which leads to the extension of the spring 1. As a result, the spring 1 may store the force. Thus, further opening the door by the user from the opening operation position after the pop-up operation causes the external force to be applied to the spring 1 so that the spring 1 stores the force for the next pop-up operation of the door by the pop-up mechanism 100 without the intension of the user” (see e.g., ¶ 0025).

That is, a complicated structure of two levers connected via a gear and spring and so on was essentially necessary for the door pops up due to action of the spring.

In JP A 2017-515014, a problem of “the usual outer door handles are always used in order to provide an engagement surface for the hand of the user during the manual movement of the closure element. The realization of such outer door handles, which are arranged on the outer skin of the closure element, is aerodynamically disadvantageous, results in risks of injury in event of a crash, limits the design freedom, and entails considerable costs” (see e.g., ¶ 0004) has been solved and an invention of “to provide motor vehicle lock arrangement so that an optimized realization of an engagement surface for the user's hand is made possible with low costs” (see e.g., ¶ 0005) has been disclosed. While it is said that “the closure element 3 can be moved by means of the servo drive 6 in a motorized positioning process from a closed position represented in FIG. 1a into a gap position represented in FIG. 1b, so that an engagement gap 8 can be created between closure element 3 and motor vehicle body 2” (see e.g., ¶ 0024), servo drive 6 is required, the structure is complicated and has a large number of parts.

In FIG. 8 of U.S. Patent Application Publication No. 2015/0330133, an assembly is disclosed that applies a pressing force to the door check itself to open the door in a half opening state. This assembly has a configuration in which the actuator 106 pushes out the spring 126 to push out the lever 116 to the half opening position, thereby pushing out the link 604 of the door check to the half opening position (see e.g., ¶ 0046). However, this assembly requires a lot of additional parts in order to open the door half opening state, such as the actuator 106 for pushing out the spring 126 and the lever 116 for pushing out the link.

### SUMMARY

It is against the above background that the instant disclosure provides certain advantages over the prior art.

The instant inventors were first to discover a door check of a hinged door including a door side component and a body side component.

Although this invention as described herein is not limited to specific advantages or functionalities (such for example, a door check of a hinged door including a door side component and a body side component), the disclosure provides a door check of a hinged door, the door check comprising: a door side component, a body side component, a check link arm included in one of the door side component and the body side component and penetrating a housing, wherein the housing is included in the other one of the door side component and the body side component, a stress generating structure generating elastic stress in a door opening direction at a fully closed state of the door, and applying the stress directly onto the check link arm, the stress generating structure being configured to partially open the door by the stress when a latch, which maintains the door in the closed state, is released.

In some aspects of the door check of the hinged door disclosed herein, the partial open state of the door results in the opening of 1 cm to 10 cm at the door end other than the hinge side end of the door.

In some aspects of the door check of the hinged door disclosed herein, the opening direction stress is 5 to 50 N at a door handle position.

In some aspects of the door check of the hinged door disclosed herein, a check position at which the door is held in the position of partial open state made by the opening direction stress is provided.

In some aspects of the door check of the hinged door disclosed herein, the stress generating structure is configured so that the door checking force generates stress in the door opening direction at the fully closed state of the door, due to a force from a slope shape of the check link arm of the door check itself and a reaction force from an elastic body inside the housing.

In some aspects of the door check of the hinged door disclosed herein, the stress generating structure is an elastic body pinched between the check link arm and the housing.

In some aspects of the door check of the hinged door disclosed herein, the elastic body is fixed to and integral with the check link arm.

A check link arm is included in one of the door side component and the body side component and penetrates a housing, where the housing is included in the other of the door side component and the body side component. A stress generating structure generates elastic stress in a door opening direction at a fully closed state of the door and applies the stress directly onto the check link arm. The stress generating structure is configured to partially open the door by the stress when a latch, which maintains the door in the closed state, is released.

These and other features and advantages of the instant disclosure will be more fully understood from the following detailed description taken together with the accompanying claims. It is noted that the scope of the claims is defined by the recitations therein and not by the specific discussion of features and advantages set forth in the instant description.

### BRIEF DESCRIPTION OF THE DRAWINGS

The following detailed description of the embodiments of the instant disclosure can be best understood when read in conjunction with the following drawings, where like structure is indicated with like reference numerals and in which:

FIG. 1 shows a door check according to an embodiment of the present invention.

FIG. 2 shows a door check according to another embodiment of the present invention, wherein an elastic body is different from the one shown in FIG. 1.

FIG. 3 shows a door check according to an embodiment of the present invention, wherein the door is checked to stop in a partial open position at a partial open state. FIG. 3a corresponds to FIG. 2, and FIG. 3b to FIG. 1.

FIG. 4 shows the partial open state of a door check according to an embodiment of the present invention, which generates stress from both elastic body and pressure force on slope face, with only check rollers shown and other parts of the housing not shown.

FIG. 5 shows a door check according to another embodiment of the present invention, which uses only opening direction stress generated by the slope face and the check slider or roller.

FIG. 5a shows the housing, containing the check slider or roller, and check link arm at a fully closed state, and FIG. 5b shows only the check link arm.

Skilled artisans will appreciate that elements in the Figures are illustrated for simplicity and clarity and have not necessarily been drawn to scale. For example, the dimensions of some of the elements in the Figures can be exaggerated relative to other elements to help improve understanding of the embodiment(s) of the instant disclosure.

### DETAILED DESCRIPTION

All publications, patents and patent applications cited herein are hereby expressly incorporated herewith by reference for all purposes.

Before describing the instant disclosure in detail, a number of terms will be defined. Unless otherwise required by context, singular terms shall include pluralities and plural terms shall include the singular, unless specifically stated otherwise. For example, the singular forms “a,” “an,” and “the” include plural referents unless the context clearly dictates otherwise. It should be understood that the terms “a” and “an” as used herein refer to “one or more” of the enumerated components unless otherwise indicated or dictated by its context. It should also be understood that the word “a” or “an” means “at least one” unless specifically stated otherwise. The use of “or” means “and/or” unless stated otherwise. The meaning of the phrase “at least one” is equivalent to the meaning of the phrase “one or more.” Furthermore, the use of the term “including,” as well as other forms, such as “includes” and “included,” is not limiting. Also, terms such as “element” or “component” encompass both elements or components comprising one unit and elements or components comprising more than one unit unless specifically stated otherwise.

The use of the alternative (e.g., “or”) should be understood to mean either one, both, or any combination thereof of the alternatives unless otherwise indicated.

In the instant disclosure, any concentration range, percentage range, ratio range, or integer range is to be understood to include the value of any integer within the recited range and, when appropriate, fractions thereof (such as one tenth and one hundredth of an integer), unless otherwise indicated.

As used herein, the terms “about” and “approximately,” when used to modify numeric value or numeric range, indicate that reasonable deviations from the value or range, typically 5% or 10% above and 5% or 10% below the value or range, remain within the intended meaning of the recited value or range.

It is noted that terms like “preferably,” “commonly,” and “typically” are not utilized herein to limit the scope of the claimed subject matter or to imply that certain features are critical, essential, or even important to the structure or function of the claimed subject matter. Rather, these terms are merely intended to highlight alternative or additional features that can or cannot be utilized in a particular embodiment of the instant disclosure.

The present invention provides a door check of a vehicle, which enables a finger to be inserted, in order to open the door, to move a door in the opening direction when a latch is released, with a simpler and more rational structure by providing a function for generating stress in opening direction in the door check.

An elastic component is provided to a conventional door check, the elastic component is pinched between a check link arm and a component through which the arm penetrates, wherein, at a fully closed state of the door, the elastic component is compressed to generate stress in door opening direction, and the door is pushed in the opening direction by the stress when the latch is released.

Because it is elastic component, the door can be closed against the elastic force in door closing direction, and a force required to bring the door to partial open state is generated by the elastic force stored by compressing the elastic component during door closing.

A configuration may be employed with a check link arm, wherein a slope face, on which a slider or a roller pressing the check link arm of the door check moves, is formed so that an opening direction stress is generated at a fully closed state of the door.

The door is positioned at a slightly opened state by the check, and the door is further manually opened by an operator. When the latch is released, the door will open and stop at a suitable opening angle, allowing the operator to insert finger and open the door.

Therefore, the structure is extremely simple and does not require a complicated driving mechanism such as an actuator.

The present invention provides a simpler structure for keeping the door at half opening state when the door latch is released. In particular, the present invention provides a door check of a vehicle, which enables a finger to be inserted to move a door in the opening direction when a latch is released in order to open the door, with a simpler and more rational structure by providing a function for generating stress in opening direction in the door check.

The present inventors conducted extensive studies to solve the above problems, obtained the following findings, and further pursued studies to complete the present invention.

To a conventional door check, an elastic component which is put between a check link arm and a component through which the arm penetrates is provided, wherein, at a fully closed state of the door, the elastic component is compressed to generate stress in door opening direction, and the door is pushed in the opening direction by the stress when the latch is released.

Because it is an elastic component, the door can be closed against the elastic force in door closing direction, and a force required to bring the door to partial open state is generated by the elastic force stored by compressing the elastic component during door closing.

A configuration may be employed with a check link arm, wherein a slope face, on which a check slider or a roller which presses the check link arm of the door check with elastic force roles, is formed so that a stress is generated in opening direction at a fully closed state of the door. Also in this configuration, the force required to bring the door to partial open state is generated by the elastic force stored when the door is closed, against the pressing force exerted by the slider or roller.

The door is once positioned at a slightly opened state by the check, after which the door is manually opened further by an operator. When the latch is released, the door will open and stop at a suitable opening angle, allowing the operator to insert finger and open the door.

Therefore, the structure is extremely simple and does not require a complicated driving mechanism such as an actuator.

The present invention comprises the following embodiments:
(1) A door check of a hinged door for opening/closing, comprising door side component and body side component, wherein a check link arm being included in one of the door side component and the body side component and penetrating a housing being included in the other one of the door side component and the body side component, wherein the door check has a stress generating structure generating elastic stress in door opening direction at a fully closed state of the door, and applying the stress directly onto the check link arm, the stress generating structure being configured to partially open the door by the stress when a latch, which maintains the door in the closed state, is released;
(2) The check according to (1), wherein the partial open state of the door results in the opening of 1 cm to 10 cm at the door end other than the hinge side end of the door;
(3) The door check according to (1) or (2), wherein the opening direction stress is 5 to 50 N at a door handle position;
(4) The door check according to any one of (1) to (3), wherein a check position at which the door is held in the partial open position due to the stress to opening direction is provided;
(5) The door check according to any one of (1) to (4), wherein the stress generating structure is configured so that the door checking force generates stress in door opening direction at the fully closed state of the door, due to a force from a slope shape of the check link arm of the door check itself and a reaction force from an elastic body inside the housing;
(6) The door check according to any one of (1) to (4), wherein the stress generating structure is the elastic body pinched between the check link arm and the housing;
(7) The door check according to (6), wherein the elastic body is fixed to and integral with the check link arm.

The inventors of the present invention reached to the aforementioned configurations by focusing on that the configurations of the prior art are too complicated.

That is, by the aforementioned configurations, a driving mechanism such as an actuator is not required, and the stress can be stored in the elastic body by simply applying stress to bring the door to the fully closed state, and the stress pushes the door to the half opening state thereafter.

Alternatively, storing stress in the elastic body toward half opening direction of the door can be achieved by an opening direction force generating structure generating a pressure using a check roller pressing against a slope shape face forming a concave part at the check position on the check link arm of the door check.

In this case, concave and convex shape is provided on the side of the check link arm, and the check slider or roller is pressed against the side with elastic force to produce checking function on the door check. When the check slider or roller rolls along the concave and convex shape, the check slider or roller is held in the concave part by the pressing force to produce the checking function. The concave and convex shape of the check link arm is configured so that the pressing force exerted by the check slider or roller pressing against the concave and convex slope face is exerted as stress in the door opening direction at a fully closed state of the door. This is the opening direction stress generating structure of one of the embodiments of the present invention, in which slope shape face is pressed.

In the case that concave and convex shape on check link arm is configured so that the gap for door operation is the desired one at the first check position, the stress in the door opening direction disappears at the first check position and the door stops at the desired half opening position.

According to the present invention, despite its extremely simple configuration, the above-mentioned function, i.e., releasing the latch for door opening allows the stress stored when the door being closed to drive the door in the opening direction becomes possible.

In order to achieve desired size of the door gap for further manual opening, it is possible to configure suitable setting of door check stop position for the door driven in the opening direction.

By configuring the elastic body to be fixed to the check link arm of the door checker, it is possible to replace the elastic body at the same time as replacing the check link arm, which facilitate keeping its functions.

Furthermore, the structure of the present invention enables a door automatically forming a gap for a hand when the door latch is released, by simply replacing a conventional door check that does not have a partial door opening function with the door check that has the elastic body of the present invention, in which no additional parts are required. Additionally, such a simple configuration has remarkable effect of requiring little or no space for the additional function.

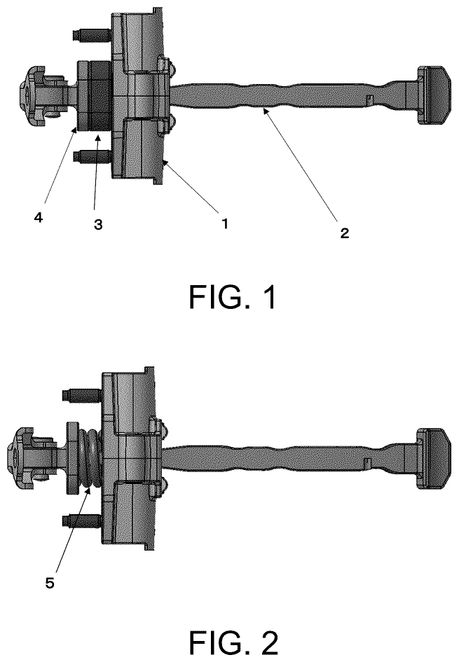

FIG. 1 shows overall structure of an embodiment of the door check of the present invention.

In this drawing, for the sake of clarity, door and vehicle body are not shown, and only the checker is shown.

The door check is a device for holding the check link arm at preset check position(s) with its pressing force wherein concave and convex shape is provided on the surface of the check link arm 2 penetrating through the housing 1 fixed to the door, and a slider or a roller being a pressing component provided inside the housing 1, slides along the concave and convex shape.

The present invention includes a mechanism for directly applying stress to the check link arm, which, in the embodiment shown in FIG. 1, is an elastic body 3 provided at the end of the check link arm 2 on the body side. This elastic body 3 is, for example, a rubber block 3 in FIG. 1, and when the door is completely closed, it is put between body side end flange 4 of the check link arm and the housing 1, and is compressed to smaller than its natural state dimension. Therefore, when the door is completely closed, the elastic body 3 generates a stress in the direction of opening the door, between the check link arm end flange 4 and the housing 1.

Once a latch closing the door is released and the door becomes pivotable, the elastic force stored in the elastic body 3 causes the door to move in a direction which separates the housing 1 and the rod end flange 4.

In order to stop the door at an opening angle that is just suitable for putting a hand as described above, a concave part for checking may be provided in the check link arm at the position where the door opening is just at such angle.

FIG. 2 shows an example in which a helical spring 5 is used as an elastic body instead of the rubber block 3 shown in FIG. 1.

The spring is not limited to helical spring, and any type of spring may be used. Also, instead of elastic block such as a rubber block or the spring, a gas-filled balloon or any other material which can store elastic force by compression may be used.

FIG. 2 shows an embodiment in which the check link arm penetrates through the center of the elastic body.

Further, a plurality of elastic bodies may be used instead of single one, but they should be arranged such that the releasing direction stress is applied directly to the check link arm.

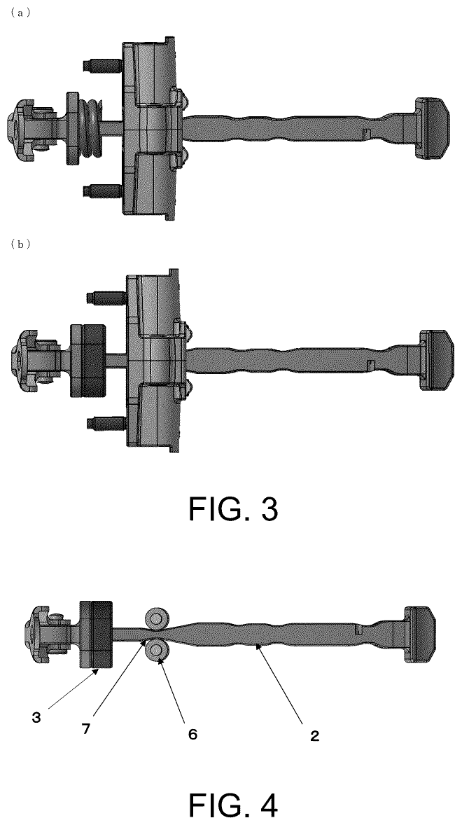

FIG. 3 shows the door check at a partial open state, the gap being just large enough to put finger in, as described above. Further, FIG. 3(b) corresponds to FIG. 1, and FIG. 3(a) to FIG. 2.

In FIG. 3, at the partial open state, the elastic body does not have pressing force at all and is not compressed, a natural state is realized.

In another embodiment, a check position may be set at a position where, at the partial open state, the check force is sufficient to hold the door, but said elastic body is compressed to the extent that a pressing force in the door opening direction still remains. This setting has an advantage that further opening by hand can be performed more easily.

The partial open state of the door may be decided to be any desired dimension, but preferably it is an opening of 1 cm to 10 cm at the door end other than the door hinge side end.

FIG. 4 shows an embodiment of a mechanism for generating stress in the door opening direction at the fully closed state, wherein check rollers 6 installed inside of the housing are pressed onto the check link arm so that the pressing force of the check rollers 6 being pressed on concave and convex slope face 7 by elastic force is converted into a force which drives the arm to the door opening direction.

In FIG. 4, the pressing force is generated by the rollers 6, but it is not limited to roller but any check slider with any configuration allowing movement on the surface may be used as far as the structure has a mechanism which applies pressing force onto the check link arm.

In FIG. 4, only the check slider or rollers 6 and the check link arm 2 are shown, and the housing 1 being a part through which the check link arm 2 penetrates, and containing the check slider or rollers 6 is omitted.

The state in FIG. 4 shows the position of the rollers stopping at the partial open state. At fully closed state, the check rollers 6 are located on the left side slope face 7, and the force with which the rollers are pressed against the arm generates stress in the direction of pushing the check link arm out, i.e., in the opening direction.

In the example of FIG. 4, a block-shaped elastic body 3 is also provided, and a release force from the elastic body is also applied in addition to the release force from the check slider or roller on the slope face 7.

The example in FIG. 4 has relatively small slope face 7, but the slope size is large enough if the stress in the door opening direction is generated at the fully closed state of the door.

The stress in the opening direction may be generated only from the elastic body at the fully closed state of the door. In other words, the check slider or rollers may pass through the slope face 7 and stay on a flat surface position at the fully closed state.

Only the slider or roller and the slope face, or only the elastic body, or any combination thereof can be used depending on situation.

The stress in opening direction can be adjusted to any magnitude, but is preferably 5 to 50 N, and more preferably 10 to 20 N, at the door handle position.

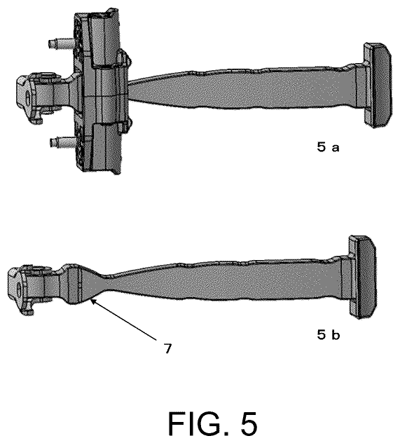

FIGS. 5a and 5b are drawings of an embodiment of a door check without elastic body using only the stress in the opening direction from the check slider or roller and slope shape face. FIG. 5a is a drawing showing the housing containing the check slider or roller and the check link arm at fully closed state. FIG. 5b is a drawing showing the check link arm only.

In FIG. 5a, the door is at the fully closed state, and the check slider or roller 6 is positioned on the slope face 7 of the check link arm so that the force onto the check link arm 2 in the opening direction is generated by the pressing force from the check slider or roller 6.

When the door closing latch is released, the door opens by the force which moves the check link arm 2 in the opening direction, in which the force is exerted by the check slider or roller 6 pressing against the slope face 7, the check slider or roller 6 reaches at the stable position of the check link arm 2 realizing the partial open state, resulting in the state shown in FIG. 4, and the door is held at the partial open state.

The check link arm 2 shown in FIG. 4 has an elastic body 3 at a position between door-side component and body-side component, while the ones in FIGS. 5a and 5b do not have such an elastic body.

According to the present invention, it is possible to install the device easily in the position where conventional check link arm is installed, regardless of whether the device is the one where stress is generated in the opening direction at fully closed state by the elastic body put between the check link arm 2 and the housing 1, or where stress is generated in the opening direction at fully closed state by the force of the check slider or roller 6 pressing against the slope face provided on the check link arm 2, or whether the device is the one having both the elastic body and the slope face for generating stress in the opening direction. In this way, an automatic opening operation to the partial open state can be realized, which could not be achieved by the conventional check link arms, and resulting in an operation to keep the door in the stable position at the partial open state without any design change, or with only minimal design change.

The operational effect of being able to automatically move to the partial open position with such a simple structure is a special effect that could never be predicted from conventional structure which require special additional structures to achieve partial opening.

Having described the subject matter of the disclosure in detail and by reference to specific embodiments thereof, it will be apparent that modifications and variations are possible without departing from the scope of the claimed subject matter. More specifically, although some aspects of the instant disclosure are identified herein as particularly advantageous, it is contemplated that the present subject matter is not necessarily limited to these particular aspects of the claimed subject matter.

What is claimed is:

1. A door check of a hinged door, the door check comprising:
a door side component,
a body side component,
a check link arm included in one of the door side component and the body side component and penetrating a housing,
wherein the housing is included in the other one of the door side component and the body side component,
a stress generating structure generating elastic stress in a door opening direction at a fully closed state of the door, and applying the stress directly onto the check link arm, the stress generating structure being configured to partially open the door by the stress when a latch, which maintains the door in the closed state, is released.

2. The door check of claim 1, wherein the partial open state of the door results in the opening of 1 cm to 10 cm at the door end other than the hinge side end of the door.

3. The door check of claim 1, wherein the opening direction stress is 5 to 50 N at a door handle position.

4. The door check of claim 1, wherein a check position at which the door is held in the position of partial open state made by the opening direction stress is provided.

5. The door check of claim 1, wherein the stress generating structure is configured so that the door checking force generates stress in the door opening direction at the fully closed state of the door, due to a force from a slope shape of the check link arm of the door check itself and a reaction force from an elastic body inside the housing.

6. The door check of claim 1, wherein the stress generating structure is an elastic body pinched between the check link arm and the housing.

7. The door check of claim 6, wherein the elastic body is fixed to and integral with the check link arm.
